(19) United States
(12) Patent Application Publication
(10) Pub. No.: US 2011/0130212 A1
(43) Pub. Date: Jun. 2, 2011

(54) Variable Axial-Angle Coupling

(76) Inventor: Mordehai Sholev, Moshav Amikam (IL)

(21) Appl. No.: 13/056,238

(22) PCT Filed: Jul. 27, 2009
(86) PCT No.: PCT/IL2009/000729

§ 371 Date: Jan. 27, 2011

Related U.S. Application Data
(60) Provisional application No. 61/083,956, filed on Jul. 28, 2008.

(51) Int. Cl. F16D 3/18

(52) U.S. Cl. 464/150

(57) ABSTRACT

The present invention provides a constant velocity joint comprising: a. n coaxial input shafts rotatable around an input axis of rotation by m sources of independent torques; b. n coaxial input transmission means, each of which is coupled to one of said n input shafts; said input transmission means defining a first plane substantially perpendicular to said input axis of rotation; c. n coaxial second transmission means rotatably connected to said n input transmission means; said second transmission means rotating in a second plane; d. n coaxial output transmission means rotatably connected to said n second transmission means; said output transmission means rotating in a third plane; e. n coaxial output shafts, each is coupled to one of said n output transmission means; wherein the angle between said input axis of rotation and said output axis of rotation varies in said second plane in an unlimited angular range.

### FIELD OF THE INVENTION

The present invention relates to a method and apparatus for a transmission that allows variation of direction of the axis of rotation of a rotating member, as in a Cardan or CV joint, but allowing unlimited rotation of the direction of said axis in a complete circle.

### BACKGROUND OF THE INVENTION

In many mechanical systems there arises the need to transfer torque from an input shaft to an output shaft. A wide variety of gear systems have been devised for this purpose. In a number of important cases the output shaft must vary the direction/angle of its axis of rotation with respect to the input shaft. This is the case for example in a front-wheel-drive car. The engine must provide torque to the wheels, to move the car forward. However the front wheels must also be allowed to change their axis of rotation, to allow steering of the car.

The so-called universal joint, aka U-joint, Cardan joint, Hardy-Spicer joint, or Hooke's joint is often employed for purposes of allowing variation of the output axis direction. This is a joint in a rigid rod that allows the rod to ‘bend’ in any direction, and is commonly used in shafts that transmit rotary motion. It consists of a pair of ordinary hinges located close together, but oriented at 90° relative to each other. See FIG. 1a-1d for illustrations of this common joint. The concept of the universal joint is based on the design of gimbals, which have been in use since antiquity.

There are several known drawbacks to the simple U-joint. When the two shaft axes are at an angle other than 180° (straight), the driven shaft does not rotate with constant angular speed in relation to the drive shaft; as the angle approaches 90° the output rotation gets jerkier (and clearly, when the shafts reach the 90° perpendicular situation, they lock and will not operate at all). We note that our measurement of angle between output and input shaft is consonant with standard mathematical practice. Namely, when the input and output shaft are parallel in the ‘unbent’ configuration, the angle between them is 180°. As the output shaft is bent, this angle decreases until reaching 90° when the shafts are perpendicular, and 0° when the output shaft is bent back upon the input shaft.

Joints have been developed utilizing a floating intermediate shaft and centering elements to maintain equal angles between the driven and driving shafts, and the intermediate shaft. This overcomes the problem of differential angles between the input and output shafts.

The CV joint or constant velocity joint finds actual use in automotive applications. As shown in FIG. 2 this is a joint connecting the input axle 201 to the output axle 205. The splines 204 spin the spokes 209 which in turn spin the plurality of ball bearings 202 on the inner ball race 203. These balls are confined between the ball cage 206 and the outer socket 207, which has depressions 210 into which the balls fit. Since the balls are confined by both axles, they transfer the torque from the input axle 201 to the output axle 205. An isometric view is given in FIG. 2b. The two main failures are wear and partial seizure. Furthermore it will be appreciated that extreme angles between input and output shafts of around 90 or less will not be capable of transferring torque at all, and in practice a continuous angle of about 100° degrees is the highest deviation from the straight 180° configuration obtainable with a CV joint.

The double Cardan or double U-joint allows for a constant velocity to be attained at the output shaft, unlike the single U-joint. An improvement on this is two Cardan joints assembled coaxially where the cruciform-equivalent members of each are connected to one another by trunions and bearings which are constrained to continuously lie on the homokinetic plane of the joint. This is the basis of US patent application 20060217206. Therein is disclosed a constant velocity coupling and control system therefore, the so-called ‘Thompson coupling’, as shown in FIG. 3. A recent innovation, the Thompson coupling is a further development of the double Cardan-joint, which doesn't rely on friction or sliding elements (as the CV joint does) to maintain a strict geometric relationship within the joint, and which is capable of transmitting torque under axial and radial loads with low frictional losses. This coupling has all loads carried by roller bearings, with no sliding or skidding surfaces whatsoever. It can tolerate axial and radial loads without degradation, with no wearing components except replaceable bearings and trunnions, and is less bulky than a double Cardan joint. However as will be appreciated from FIG. 3, this is a rather complex affair. Furthermore the maximum allowable angles are still restricted, e.g. to an instantaneous allowable angle of 155° and maximum continuous of 168°.

Hence, a system for constant-velocity transmission of torque at a wide angular range of possible output directions is still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1a-d present a Universal Joint, also known as the U-joint or Cardan joint;

FIG. 2a-b present a constant-velocity or CV joint;

FIG. 3 presents a Thompson joint, this being a type of double Cardan joint;

FIG. 4a,b presents an embodiment of the variable coupling of the present invention in realistic and outline views, respectively;

FIG. 5a,b, presents an embodiment of the variable coupling of the present invention in realistic and outline views, respectively;

FIG. 6 presents an isometric view of a second embodiment of the variable coupling of the present invention;

FIG. 7 presents a different isometric view of the second embodiment of the variable coupling of the present invention;

FIG. 8 presents a series of three of the variable couplings of the present invention in series; and

FIG. 9 presents a two-wheel-drive bicycle with front and rear suspension and no chain, based on the coupling of the instant invention.

FIGS. 10-13 present another embodiment of the present invention.

FIGS. 14a-14c illustrate a possible mechanism for locking the angle of the output shaft with respect to the input shaft.

FIGS. 15a-15b, 16a-16f and 17a-17c illustrate coupling of n variable couplings of the invention.

FIG. 18 illustrates a mechanism that enables 360 degrees change in direction.

FIG. 19a-19c illustrate an embodiment allowing unlimited rotation of the output shaft axis of rotation with respect to the input shaft axis of rotation.

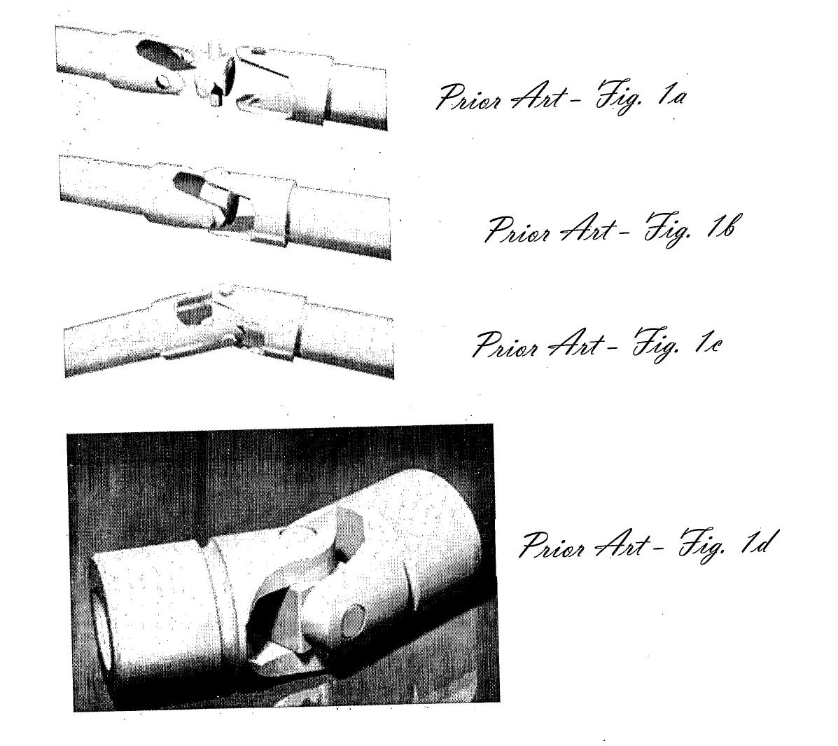

### SUMMARY OF THE INVENTION

The present invention provides a torque-transmitting joint similar to a u-joint, cardan, or CV joint. It consists in its simplest form of: an input shaft connected to an input bevel gear; an intermediate bevel gear connected to the input gear at right angles; and an output bevel gear connected to the intermediate bevel gear at right angles and also connected to an output shaft. The output shaft axis of rotation may now vary with respect to the input shaft axis of rotation, as in a CV or U-joint, but with 360 degrees of rotation possible. It should be further mentioned that an unlimited rotation is enabled.

Further variations on this theme include using multiple coaxial shafts to transmit optionally several different torques simultaneously to different directions; locking the output shaft direction in order to vary the position of the joint itself; providing several output shafts for a single input shaft; using several such joints in series to achieve high degrees of freedom in e.g. robotic arms, and the like.

It is an object of the present invention to provide a constant velocity joint comprising:
a. n coaxial input shafts adapted to be rotated around an input axis of rotation by m sources of independent torques, where n and m are positive integers;
b. n coaxial input transmission means, each of which is coupled to one of said n input shafts; said input transmission means defining a first plane; said first plane is positioned at an angle A with respect to said input axis of rotation;
c. n coaxial second transmission means rotatably connected to said n input transmission means; said second transmission means rotating in a second plane; said second plane is positioned at an angle A1 with respect to said first plane;
d. n coaxial output transmission means rotatably connected to said n second transmission means; said output transmission means rotating in a third plane; said third plane being positioned at an angle A2 with respect to said second plane;
e. n coaxial output shafts, each of which is coupled to one of said n output transmission means, said n output shafts being adapted to rotate around an output axis of rotation;
whereby turning a given input shaft at a constant velocity will provide a constant velocity at the corresponding output shaft, and furthermore wherein the angle between said input axis of rotation and said output axis of rotation varies in said second plane in an unlimited angular range of about 0 to about 360 degrees or greater.

It is a further object of the present invention to provide a constant velocity joint comprising:
a. a plurality of constant velocity joints each comprising:
   i. n coaxial input shafts adapted to be rotated around an input axis of rotation by M sources of independent torques, where n and in are positive integers;
   ii. n coaxial input transmission means, each of which is coupled to one of said n input shafts; said input transmission means rotating in a first plane; said first plane is positioned at an angle A with respect to said input axis of rotation;
   iii. n coaxial second transmission means rotatably connected to said n input transmission means; said second transmission means rotating in a second plane; said second plane is positioned at an angle A1 with respect to said first plane;
   iv. n coaxial output transmission means rotatably connected to said n second transmission means; said output transmission means rotating in a third plane; said third plane being positioned at an angle A2 with respect to said second plane;
   v. n coaxial output shafts, each of which is coupled to one of said n output transmission means, said n output shafts are adapted to rotate around an output axis of rotation;
b. coupling means for coupling each of said output shafts of each said constant velocity joint to said input shafts of each subsequent constant velocity joint;
turning a given input shaft at a constant velocity will provide a constant velocity at the corresponding output shaft, and furthermore wherein the angle between said first input axis of rotation and said, final output axis of rotation varies in said second planes in an unlimited angular range of about 0 to about 360 degrees or greater.

In other words, the angle between said input axis of rotation and said output axis of rotation varies in said second plane in an angular range of about 0 to about 360 degrees or greater.

It is a further object of the instant invention to provide the constant velocity joint described above, wherein said angles A, A1 and A2 are in the range of more than about 0 degrees and less than about 360 degrees.

It is a further object of the instant invention to provide the constant velocity joint described above, wherein said input transmission means, second transmission means, and said output transmission means are selected from a group consisting of gearwheels, wheels, crown gears, bevel gears, spur gears, belts, or any combination thereof.

It is a further object of the current invention to provide the constant velocity joint described above, additionally comprising
a. an axial support member (601) adapted to provide axial support to said n output shafts in said third plane; and,
b. a circular track (618) centered on the axis of rotation of said second transmission means, said axial support member being adapted to fit into said track and slide within it.

It is another object of the present invention to provide the constant velocity joint as described above, additionally comprising a radial support member (604) adapted to provide radial support to said n output shafts, said radial support member being adapted to rotate in said second plane.

It is a further object of the present invention to provide the constant velocity joint described above wherein the gear ratio between said input and output shafts is between about 10 and about 0.1.

It is a further object of the instant invention to provide the constant velocity joint described above, additionally comprising n coaxial auxiliary shafts in rotating communication with said n second transmission means, said n coaxial auxiliary shafts rotating in said second plane, and said n coaxial auxiliary shafts capable of either being driven by said input shafts or driving said input shafts.

It is a further object of the instant invention to provide the constant velocity joint described above, additionally comprising locking means adapted for preventing relative movement between one or more of said input axis shafts and said constant velocity joint, wherein said constant velocity joint is caused to rotate as a body with said locked input axis shafts.

It is a further object of the instant invention to provide the constant velocity joint described above, additionally comprising locking means for preventing relative movement between one or more of said output axis shafts and said constant velocity joint, wherein said constant velocity joint is caused to rotate as a body or as a whole with said locked output axis shafts.

It is a further object of the instant invention to provide the constant velocity joint described above, additionally comprising locking means 1403 for preventing relative movement between one or more of said output axis shafts 1401 and said constant velocity joint, wherein said constant velocity joint is caused to rotate as a body with said locked output axis shafts.

It is a further object of the instant invention to provide the constant velocity joint described above, additionally comprising one or more coaxial output shafts (1001, 1002) each coupled to said n coaxial second transmission means or to said n coaxial output transmission means.

It is a further object of the instant invention to provide the constant velocity joint described above, additionally comprising one or more additional output shafts 1302 coupled to said n coaxial second transmission means.

It is a further object of the instant invention to provide a method for transmitting torque to output shafts of variable angle comprising steps of:
a. providing n coaxial input shafts adapted to be rotated around an input axis of rotation by m sources of independent torques, where n and m are positive integers;
b. providing n coaxial input transmission means, said input transmission means defining a first plane; said first plane is positioned at an angle A with respect to said input axis of rotation;
c. coupling each of said input transmission means to one of said n input shafts;
d. providing n coaxial second transmission means rotatably connected to said n input transmission means; said second transmission rotating in a second plane; said second plane is positioned at an angle A1 with respect to said first plane;
e. providing n coaxial output transmission means rotatably connected to said n second transmission means; said output transmission means rotating in a third plane; said third plane being positioned at an angle A2 with respect to said second plane;
f. providing n coaxial output shafts, said n output shafts are adapted to rotate around an output axis of rotation; and
g. coupling each of said output transmission means to one of said n output shafts;
h. rotating one or more of said coaxial input shafts by means of an external source of torque, thereby transmitting said torque to said coaxial output shafts whilst allows varying the angle between said input axis of rotation and said output axis of rotation in said second plane in an unlimited angular range of about 0 to about 360 degrees or greater.

It is a further object of the instant invention to provide a method for transmitting torque to output shafts of variable angle comprising steps of:
a. providing a plurality of constant velocity joints each comprising:
   i. n coaxial input shafts adapted to be rotated around an input axis of rotation by m sources of independent torques, n and m are positive integers;
   ii. n coaxial input transmission means, each of which is coupled to one of said n input shafts; said input transmission means rotating in a first plane; said first plane is positioned at an angle A with respect to said input axis of rotation;
   iii. n coaxial second transmission means rotatably connected to said n input transmission means; said second transmission means rotating in a second plane; said second plane is positioned at an angle A1 with respect to said first plane;
   iv. n coaxial output transmission means rotatably connected to said n second transmission means; said output transmission means rotating in a third plane; said third plane being positioned at an angle A2 with respect to said second plane;
   v. n coaxial output shafts, each of which is coupled to one of said n output transmission means, said n output shafts are adapted to rotate around an output axis of rotation;
b. coupling said output shaft of each said constant velocity joint to said input shaft of each subsequent constant velocity joint; and
c. rotating one or more of said coaxial input shafts by means of external sources of torque, thereby transmitting torque to each of said coaxial output shafts whilst allows varying the angle between said input axis of rotation and said output axis of rotation in any plane in an unlimited angular range of about 0 to about 360 degrees or greater.

It is a further object of the instant invention to provide the method as described above, additionally comprising step of selecting said input transmission means, second transmission means, said output transmission means from a group consisting of gearwheels, wheels, crown gears, bevel gears, spur gears, belts, or any combination thereof.

It is a further object of the instant invention to provide the method as described above, additionally comprising step of selecting said angle A, A1 and A2 from the range of more than about 0 degrees and less than about 360 degrees.

It is a further object of the instant invention to provide the method as described above, additionally comprising step of providing each of said constant velocity joints with:
a. an axial support member (601) adapted to provide axial support to said n output shafts in said third plane; and,
b. a circular track (618) centered on the axis of rotation of said second transmission means, said axial support member being adapted to fit into said track and slide within it.

It is a further object of the instant invention to provide the method as described above, additionally comprising step of providing each of said constant velocity joints with a radial support member (604) adapted to provide radial support to said n output shafts, said radial support member being adapted to rotate in said second plane.

It is a further object of the instant invention to provide the method as described above, additionally comprising step of providing a gear ratio between said input and output shafts is between about 10 and about 0.1.

It is a further object of the instant invention to provide the method as described above, additionally comprising the step of providing n coaxial auxiliary shafts in rotating communication with said n second transmission means, said n coaxial auxiliary shafts rotating in said second plane, and said n coaxial auxiliary shafts either being driven by said input shafts or driving said input shafts.

It is a further object of the instant invention to provide the method as described above, additionally comprising step of preventing relative movement between one or more of said input axis shafts and said constant velocity joint via locking means, wherein said constant velocity joint is caused to rotate as a body with said locked input axis shafts.

It is a further object of the instant invention to provide the method as described above, additionally comprising step of preventing relative movement between one or more of said output axis shafts and said constant velocity joint via locking means, wherein said constant velocity joint is caused to rotate as a body with said locked output axis shafts.

It is a further object of the instant invention to provide the method as described above, additionally comprising step of providing one or more coaxial output shafts 1001, 1002 each coupled to said n coaxial second transmission means.

It is a further object of the instant invention to provide the method as described above, additionally comprising step of providing one or more additional output shafts 1302 coupled to said n coaxial second transmission means

It is a further object of the instant invention to provide an article of manufacture based upon the joint as described above, wherein said joint is used to allow variation of the angle between said input axis of rotation and said output axis of rotation in an angular range of about 0 to about n×360 degrees.

It is a further object of the instant invention wherein the article of manufacture as described above, wherein said article of manufacture is selected from a group comprising: bicycle, two-wheel-drive bicycle, robot, robotic arm, robotic arm with force feedback, remote sensing device, manipulator, and motor vehicle.

It is a further object of the invention to provide the constant velocity joint as described above comprising one or more additional output shafts coupled to said n coaxial second transmission means.

Devices based on the invention will find use in transmissions, working tools, toys, medical devices, and other applications as will be obvious to one skilled in the art.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a coupling with variable axial direction of the output with respect to the input.

The present invention provides a constant velocity joint comprising:

(a) n coaxial input shafts adapted to be rotated around an input axis of rotation by m sources of independent torques, where n and m are positive integers;
(b) n coaxial input transmission means, each of which is coupled to one of said n input shafts; said input transmission means defining a first plane; said first plane is positioned at an angle A with respect to said input axis of rotation;
(c) n coaxial second transmission means rotatably connected to said n input transmission means; said second transmission means rotating in a second plane; said second plane is positioned at an angle A1 with respect to said first plane;
(d) n coaxial output transmission means rotatably connected to said n second transmission means; said output transmission means rotating in a third plane; said third plane being positioned at an angle A2 with respect to said second plane; and,
(e) n coaxial output shafts, each of which is coupled to one of said n output transmission means, said n output shafts being adapted to rotate around an output axis of rotation wherein turning a given input shaft at a constant velocity will provide a constant velocity at the corresponding output shaft; further wherein the angle between said input axis of rotation and said output axis of rotation varies in said second plane in an unlimited angular range of about 0 to about 360 degrees or greater.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment or invention. Furthermore, the particular features, structures, or characteristics may be combined in any suitable manner in one or more embodiments. Lastly, the terms “comprising”, “including”, “having”, and the like, as used in the present application, are intended to be synonymous.

The term ‘gear ratio’ in a transmission refers to the ratio of angular velocity of the output shaft to that of the input shaft.

The term ‘transmission means’ here refers to means for transferring torque from one rotating element to another, such as gearwheels, wheels, crown gears, chain, belt and the like.

The term ‘plurality’ refers hereinafter to any integer number equal or higher 1.

The term ‘geared communication’ refers hereinafter to a relation between two mechanical parts such that when one rotates, it applies torque to the other such that the other also rotates. Thus crown gears, bevel gears, friction wheels, belts, bands, chains and the like are all included.

According to a preferred embodiment of the present invention, a method is provided that allows the transfer of torque to an output shaft whose axis of rotation may be varied continuously over 360 degrees with respect to the axis of rotation of the input shaft.

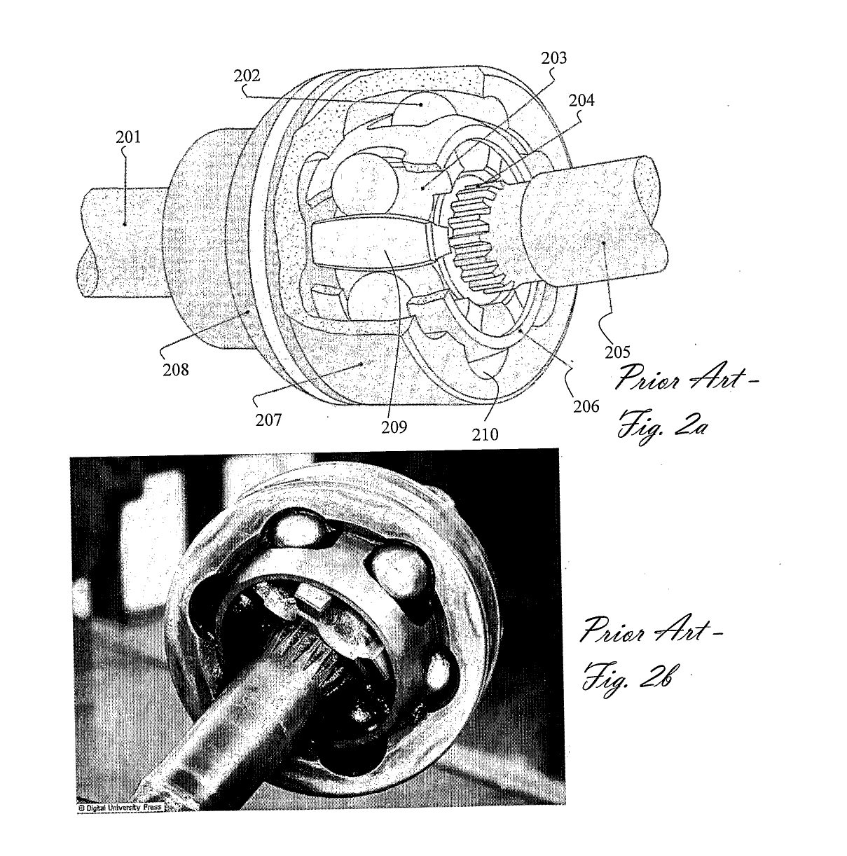

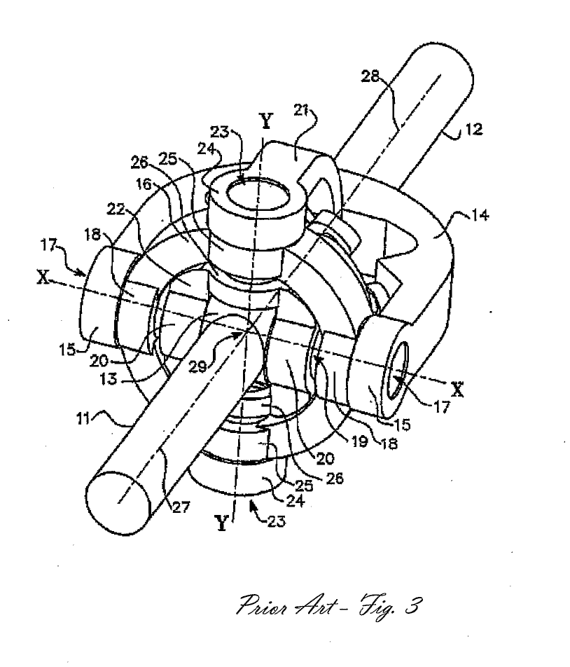

With reference to FIG. 4 a representative embodiment of the invention is detailed. The input shaft 401 provides torque from some external source. This torque is transmitted to spur gear 402. Spur gear 402 engages crown gear 403, which therefore rotates and transmits torque to the output spur gear 404. It will be appreciated by one skilled in the art that the spur and crown gears could be replaced with bevel gears or any of a number of other torque- or force-transmitting mechanisms. This simple arrangement is well known in the form of the bevel gear reversing mechanism. The key inventive step of the present invention is to allow the output shaft 405 to rotate not only about its own longitudinal axis but also about the axis 406. This is accomplished in the embodiment shown by coupling the output shaft 405 to axis 406 with a coupling that allows relative rotation of the output shaft 405 around axis 406. It will be appreciated that with this device, the output shaft 405 can be rotated in nearly a full circle around the axis 406 with no variation in the torque provided.

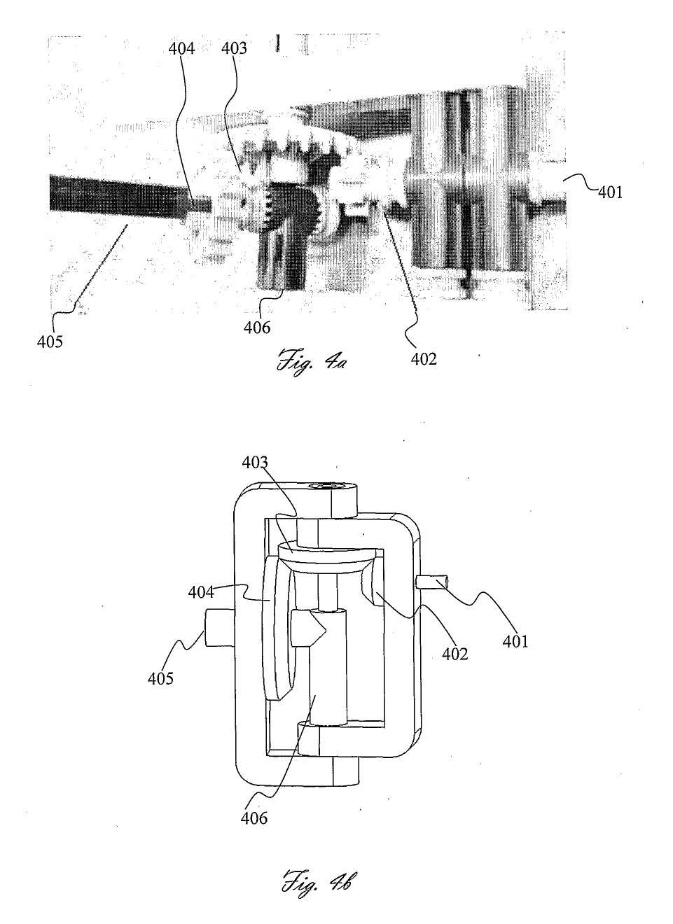

In FIG. 5 the same embodiment is shown in plan view. Torque is transmitted from an external source to input shaft 401 and from there to gearwheel 402. Gearwheel 402 engages gearwheel 403, which therefore rotates and transmits torque to gearwheel 404. The output shaft 405 is thus caused to rotate. The crux of the invention lies in the extra degree of freedom allowed to this shaft, namely that it may also rotate about the axis of the crown gear 403, this being the key provision of the invention. Axis 406 is preferentially but not necessarily largely collinear with the rotational axis of the planetary gear 403. Since the sizes of the gearwheels 402, 404 may be varied, the coupling as a whole can be made to provide a gear reduction or enlargement, with correspondingly greater or smaller output torque, and correspondingly smaller or greater rate of angular rotation.

It should be noted that due to the symmetry of the device, torque can also be transmitted in the opposite direction, from what we have called the output shaft to what we have called the input shaft. The terms ‘output’ and ‘input’ are therefore somewhat misleading since either can be used for output or input. Furthermore it will be appreciated that the change of the axis of rotation of output with respect to input is a relative one, and that therefore the input axis of rotation can be moved instead of the output axis of rotation, or both may be allowed to rotate with respect to a stationary coordinate system.

Another embodiment of the invention allows for multiple coaxial input and output shafts to be employed simultaneously. With reference to FIGS. 6,7 an example of such an embodiment is given in isometric view. The input shafts 611,612,613 are all collinear. They may be independent or dependent, as will be determined by the configuration of keyways and shafts such as 617,618 that can couple two input shafts or two output shafts such that they rotate together. The output shafts 614,615,616 are rigidly coupled to output couplings 604,603,602 respectively and therefore rotate with them. These output couplings are caused to rotate by means of crown couplings 605,606,607 respectively. The crown couplings are caused to rotate by means of input couplings 608,609,610 respectively. These input couplings are rigidly attached to input shafts 611,612,613 and therefore rotate with them. The key provision of the invention lies in the ‘extra’ degree of freedom available to the output shafts 614,615,616 which can rotate along with output couplings 604,603,602 around the axis 620. The axial support pin 601 fits into track 618 and travels with the output shafts, supporting them against axial loading. The radial support pin 621 supports the output shafts against radial loading.

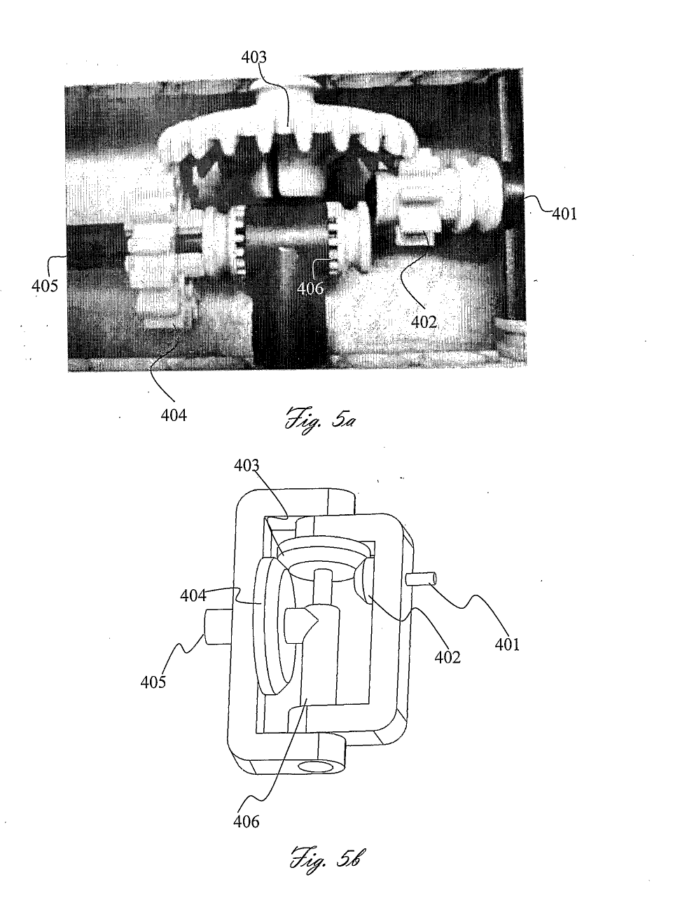

With reference to FIG. 7 the same example is shown from a slightly different angle. In this figure one can more easily see the output shafts 614,615,616 which are rigidly coupled to output couplings 604,603,602 respectively. Also more visible are the contact between these output couplings and the crown couplings 605,606,607. Also more visible here are shaft and keyway 618, 619 which couple several of the input shafts together.

A further provision of the invention is for locking of individual axes. Going back to FIG. 6 one see that bolts 622 have been introduced which lock the outermost input shaft to the body of the coupling. Therefore any attempt to rotate this input shaft will result in a rotation of the entire coupling. In FIG. 7 it will be observed that these bolts have been removed, allowing the input shaft to move freely. Similar bolts can be added to the output shafts as well, allowing the coupling to be rotated around the axis of the output shaft. It should be pointed out the output shaft axes directions are themselves variable due to the basic provision of the instant invention, and therefore the rotational axis around which the coupling is now to rotate is variable, adding yet another degree of freedom to the device.

It is within provision of the invention that the aforementioned bolts be replaced with coupling elements such as linear actuators, electromagnets, and the like. It will be obvious to one skilled in the art that such coupling elements can be so constructed that they couple or decouple electronically, allowing a further level of control over the device.

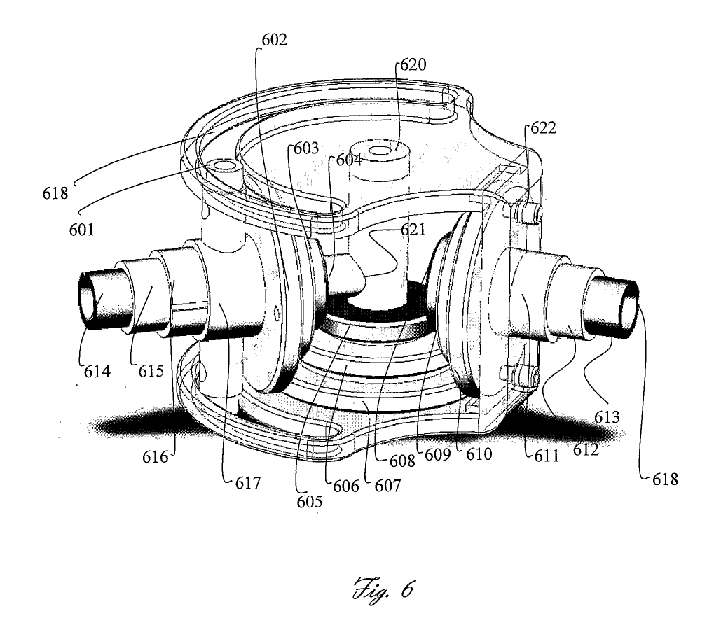

It will be noted by the astute observer that the output axis of rotation of the instant invention can rotate in a single plane only if one does not use the aforementioned provision of bolts to allow for rotation of the coupling mechanism itself. However as will be clear to one versed in the art, this restriction can be removed by the simple expedient of providing one or more further identical joints of the instant invention in series with the first, as shown in FIG. 8, where three joints 801, 802, 803 have been coupled in series. An embodiment with two or more joints in series provides a nearly full range of motion of the output shaft, in all directions relative to the input shaft. The only restriction on the angles is that the various shafts cannot physically overlap any other shaft, thus eliminating certain configurations from the realm of possibility. It will be appreciated however that the disallowed positions form a small proportion of the total universe of possibilities. This is especially relevant when considering that the possible input-output angles of e.g. single or double Cardan joints are restricted to small angles of around 168 degrees, a deviation of only 12 degrees from the ‘straight’ or unbent configuration.

It will be appreciated that the gear ratio between input and output shafts can be varied by variation of the size of the wheels or gearwheels of the couplings. In particular, if the input and output gearwheels have radii r₁, r₃ then the total gear ratio will be r₁/r₃.

The constant velocity joint of the instant invention comprises:
i. An input shaft adapted to be rotated around an input axis of rotation (the longitudinal axis of the shaft) by a sources of torque.
ii. An input transmission means, coupled to one of said input shaft, said input transmission means defining a first plane substantially perpendicular to said input axis of rotation. The input transmission means may for instance be a spur gear.
iii. A second transmission means rotatably connected to said input transmission means; said second transmission means defining a second plane, such that said second plane is substantially perpendicular to said first plane. The second transmission means may comprise for instance a crown gear meshing with the first spur gear.
iv. An output transmission means rotatably connected to said second transmission means; said output transmission means defining a third plane; said third plane being substantially perpendicular to said second plane. The output transmission means may comprise for instance a spur gear meshing with the second transmission crown gear.
v. An output shaft, coupled to said output transmission means, adapted to rotate around an output axis of rotation, said axis of rotation being free itself to rotate.

It will be noted that the angle between said first input axis of rotation and said final output axis of rotation may vary in an unlimited angular range of about 0 to about 360 degrees or greater.

The transmission means may be selected from a group consisting of gearwheels, wheels, crown gears, bevel gears, or other means for transmitting rotational motion, or combinations thereof.

In one embodiment of the invention an axial support member (601) is provided, to provide axial support to the output shafts. Also a circular track (618) centered on the axis of rotation of said second transmission means is provided, said axial support member being adapted to fit into said track and slide within it.

In one embodiment of the invention a radial support member (604) is further provided to provide radial support to the output shaft, said radial support member being adapted to rotate in said second plane.

In one embodiment of the invention several coaxial input shafts are coupled individually to several coaxial output shafts, allowing independent transmission of torque from input to output on several shafts simultaneously. Thus the magnitude, direction, angular position and time variation thereof will all be independently controllable.

It should be appreciated that the output shafts may be coupled to a wide variety of devices, such as graspers, cutters, splicers, welders, force-feedback devices, robotic hands, wheels and the like. In particular the use of force-feedback devices to provide a ‘return signal’ by means of one or more shafts will be found especially useful in microsurgery, robotics, and the like wherein it is desirable to have some feedback concerning the ‘feel’ of the work being done. With reference to FIG. 9 we illustrate one possible application of the instant invention, namely to provide two-wheel traction to a bicycle while avoiding use of a chain. For driving the front wheel variable couplings of the instant invention are provided at locations 901, 902, 903, 904. By the usual pedalling action associated with bicycling, the biker in effect provides torque to both front and back wheels, this two-wheel-drive traction being attained without use of a chain. The variable output shaft angle provided by the instant invention is necessary in this case because the frame members 907, 908, 909 are allowed to change angle with respect to one another, being coupled by the suspension elements 905, 906.

It should be pointed out that amongst other advantages of the instant invention is the fact that the torque-providing elements that turn the input shafts may be located rather distant from the location where the torque is applied. This is especially important in such fields as arthroscopy, microsurgery, and robotics, wherein it is generally desirable that the point at which delicate operations occur are as compact as possible. Also the presence of motors on or near joints can cause unwanted extra weight, moments of inertia, and the like. The instant invention allows many sources of torque to be transmitted in parallel in a minimum of space limited only by the shaft wall thicknesses, and at a distance from the actual operations of the output shafts that is in principle unlimited. No motors are required at the location of the joint itself, as in many current applications. Referring to FIG. 9 it can be appreciated that the alligator tip could be easily replaced with a many degrees-of-freedom robotic hand, splicing tool, cutting tool, welding tool, or nearly any other complex tool imaginable, requiring an arbitrary number of individual degrees of freedom.

It should be further appreciated that the instant invention allows for the actuating motors to be located in a central protected location such as the abdomen of a robot, the center portion of a tank, etc. This further allows for a single motor to activate several input shafts independently. If for example it is discovered that in a particular application certain actions requiring rotation of shaft A preclude other actions requiring rotation of shaft B, a single motor can be used to provide the torque necessary for these actions, and switched from input shaft A to input shaft B by a suitable gearbox as will be obvious to one skilled in the art.

In one embodiment of the invention access is given to the crown gears of the device, in effect changing the device into a three-terminal or ‘T’ or ‘Y’ device. In particular the central or crown gears 605, 606, 607 may be connected to input/output shafts of their own. Now more complex operations may be allowed, wherein further couplings are connected to this center shaft, or further torque sources, or further output devices such as graspers, cutters, and the like, or sensors.

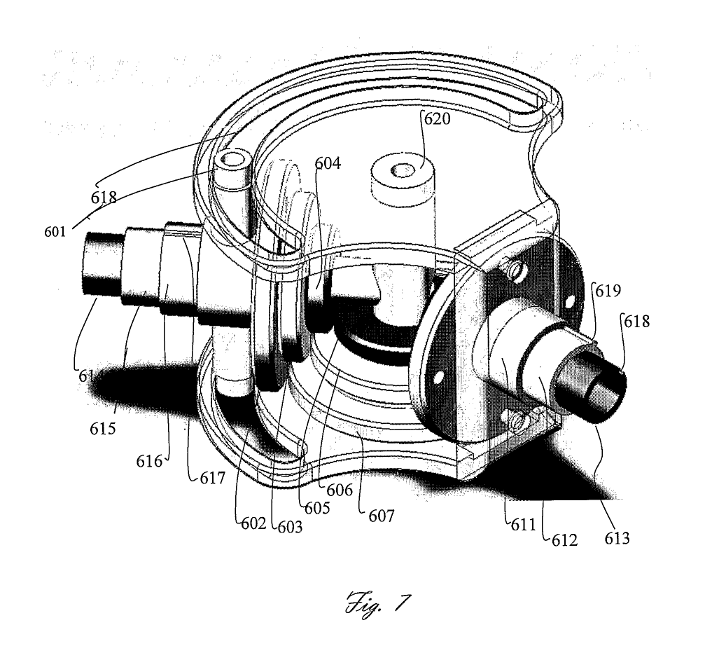

It is within provision of the invention that more than one output/input shaft be provided in one of the couplings of the instant invention, as illustrated in FIG. 10. An input shaft 1003 provides torque to both of the output shafts (1001, 1002), the mechanics of which will be elucidated below. In principle, several input shafts could also be used (with one or more output shafts), for example to increase the input torque, although this would require synchronizing the input shaft speeds.

The torque is provided to the output shafts via a rotating arm 1004.

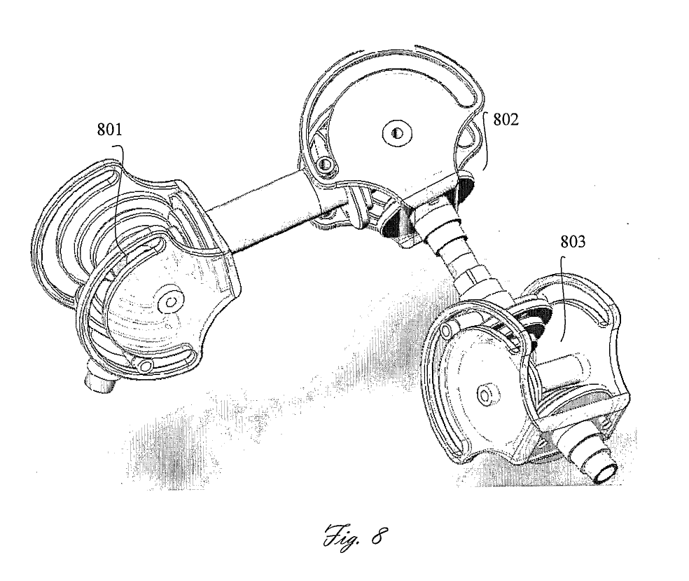

In FIG. 11 the mechanism is seen in a semitransparent isometric view. The input shaft 1003 turns upper intermediate gear 1103 by means of a chamfer or bevel gear, which turns the first output shaft 1001 as before. However the input shaft, instead of turning only the upper intermediate gear 1103, also turns a second lower intermediate gear 1104 with which it is also in geared communication. The lower intermediate gear 1104 is in communication with the second output shaft 1002, thus providing a second shaft. Note that both output shafts may change direction in 360 degrees or more, due to the fact that the output shafts are disposed such that they cannot interfere with each other.

One skilled in the art will note variations on this example that will allow more an unlimited number of output shafts, for example by means of a set of N intermediate gears for N output shafts, all fixed to a common shaft 1105 which is turned by the input gear at some point along its length. In FIG. 11 the input gear turns both intermediate gears 1103, 1104 but if each were fixed to the shaft 1105 this would in fact not be required. The directions of rotation of the output shafts with respect to the input shaft may be fixed by the particular arrangement chosen. We note that the angle between input shaft 1003 and output shafts (1001 and 1002) may be changed as in previous embodiments by means, for example, of rotating arms (1101 and 1102).

A side view of this embodiment is shown in FIG. 12.

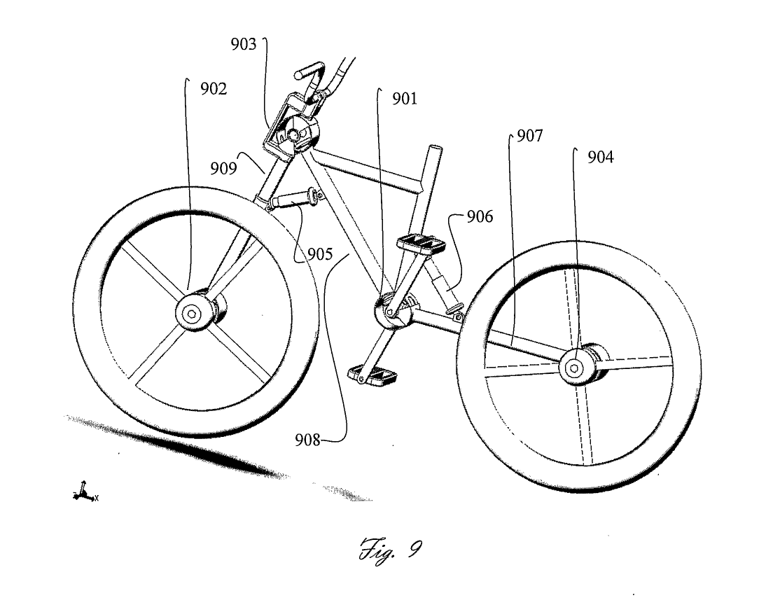

It will be obvious to one skilled in the art that the intermediate gears can also be brought out for use as additional output or input shafts. For example in the single coupling of FIG. 13, the first shaft set 1301 is coupled to intermediate shaft set 1302 which is in turn coupled to the third shaft set 1303. The intermediate shafts 1302 have been exposed at the top of the drawing, where they can be used to communicate torques just as the shaft sets 1301, 1302. We have here avoided the use of the terms ‘input’ and ‘output’, since it will be obvious to one skilled in the art that in this embodiment (as in all the others) any of the shaft sets can be used for delivering (input) or receiving (output) torque, and furthermore each individual shaft in a shaft set can be used as input or output independent of its coaxial neighbors.

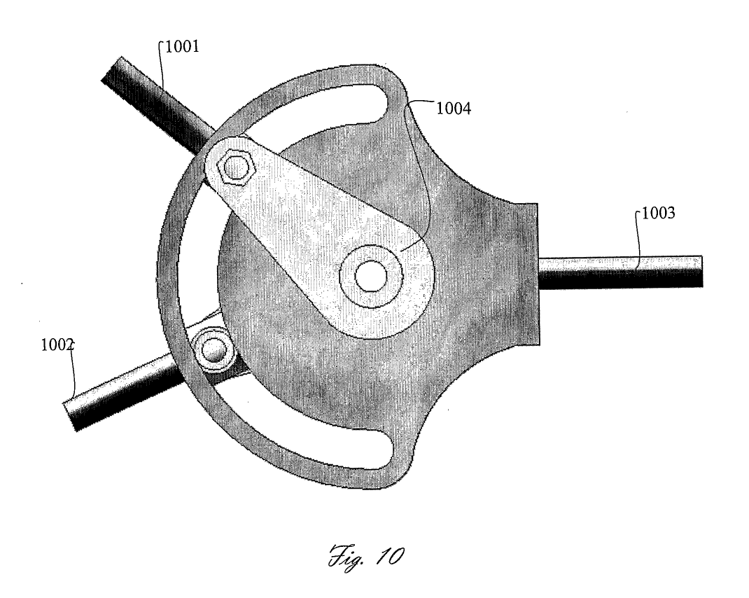

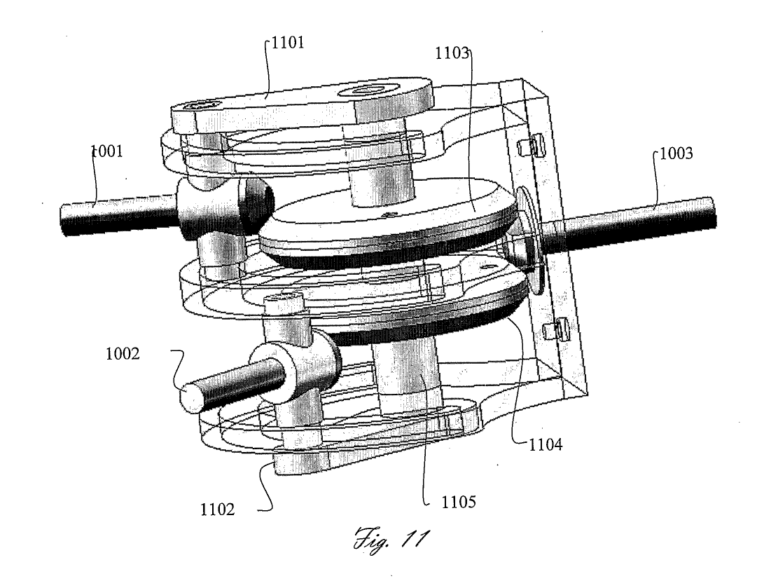

In FIG. 14a there is an illustration of a possible mechanism for locking the angle of the output shaft with respect to the input shaft. The input shaft 1402 turns intermediate gears which in turn rotate the output shaft 1401, as in the previous embodiments. By means of lock 1403 the direction of the output shaft 1401 can be fixed with respect to the input shaft 1402. This lock 1403 is released by pressing the communicating button 1404. Different views are shown in FIGS. 14b,c. The lock 1403 engages the teeth of one of the housing gears 1405,1406, which are unique to this embodiment. These gears are fixed to the body or housing of the coupling and thus locking engaging lock 1403 with the teeth of one of the housing gears 1405,1406 will fix the angle of the output shaft with respect to the housing of the device.

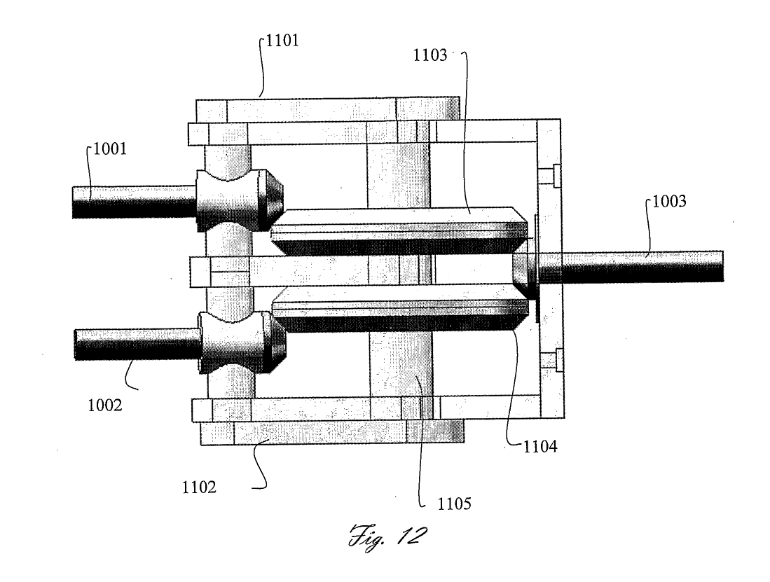

Further embodiments of the invention comprise links and chains as shown in FIGS. 15a,b. In FIG. 15a two couplings of the invention have been ganged in direct contact such that their intermediate gears 1501, 1502 are in contact. By means of this arrangement, the input axis of rotation can be fixed in a particular direction with respect to output axis of rotation by means of locks such as those shown in FIG. 14. In FIG. 15b several such links are shown in series.

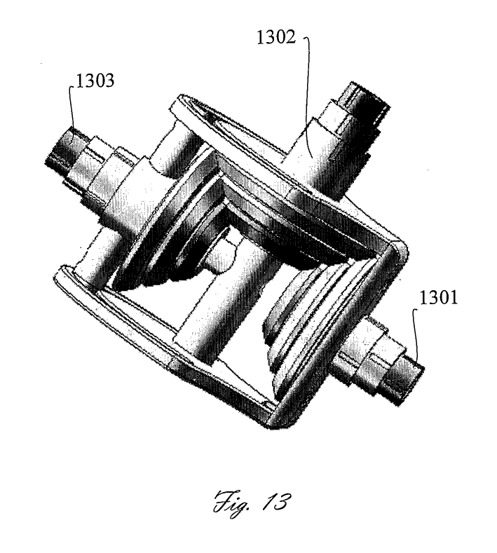

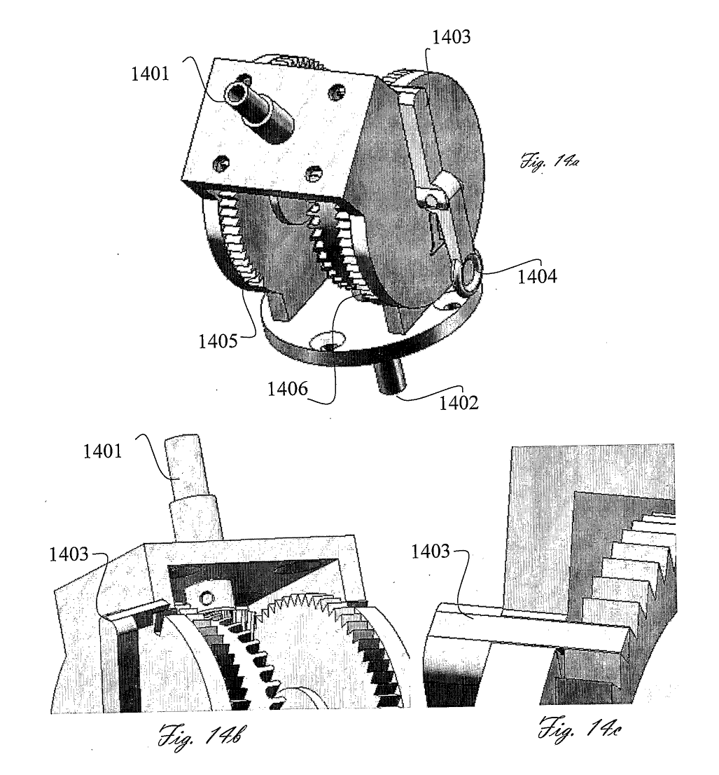

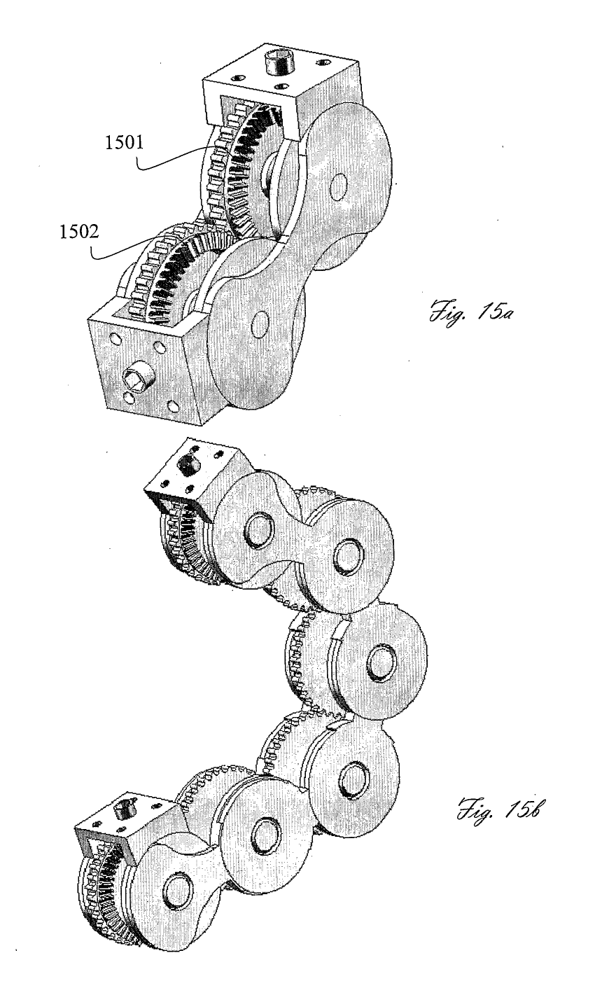

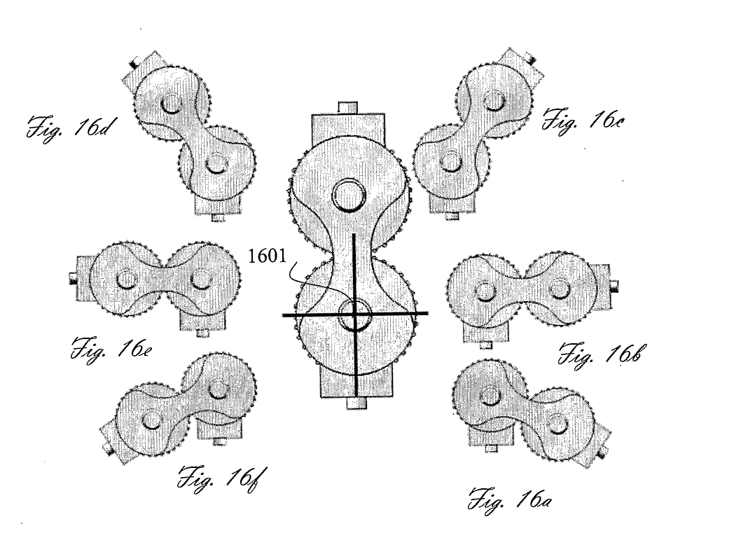

In FIG. 16 the operation of links such as those shown in FIG. 15a is shown. The links may be moved with respect to one another as in the series 16a-f, rotating about the axis 1601.

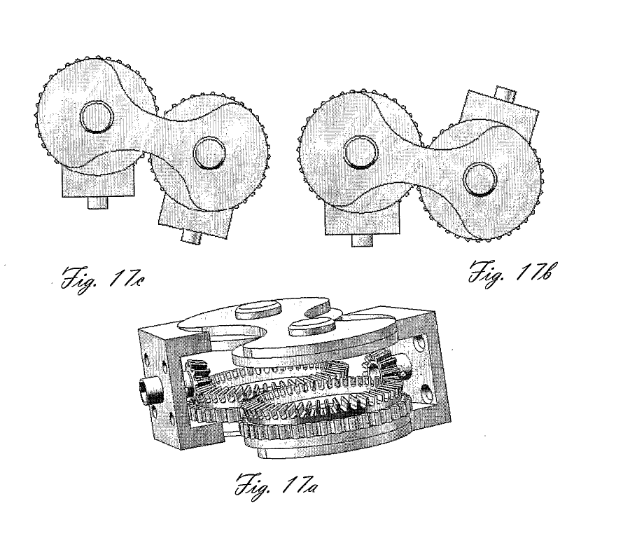

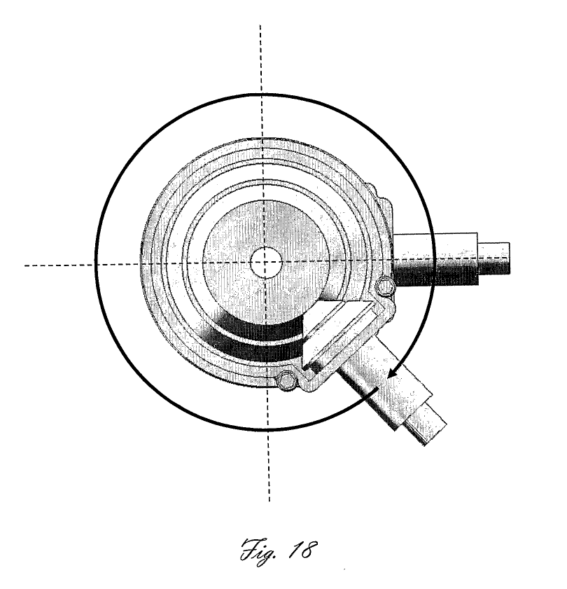

In FIGS. 17b and 17c the two extreme states of the ganged couplings 17a are shown.

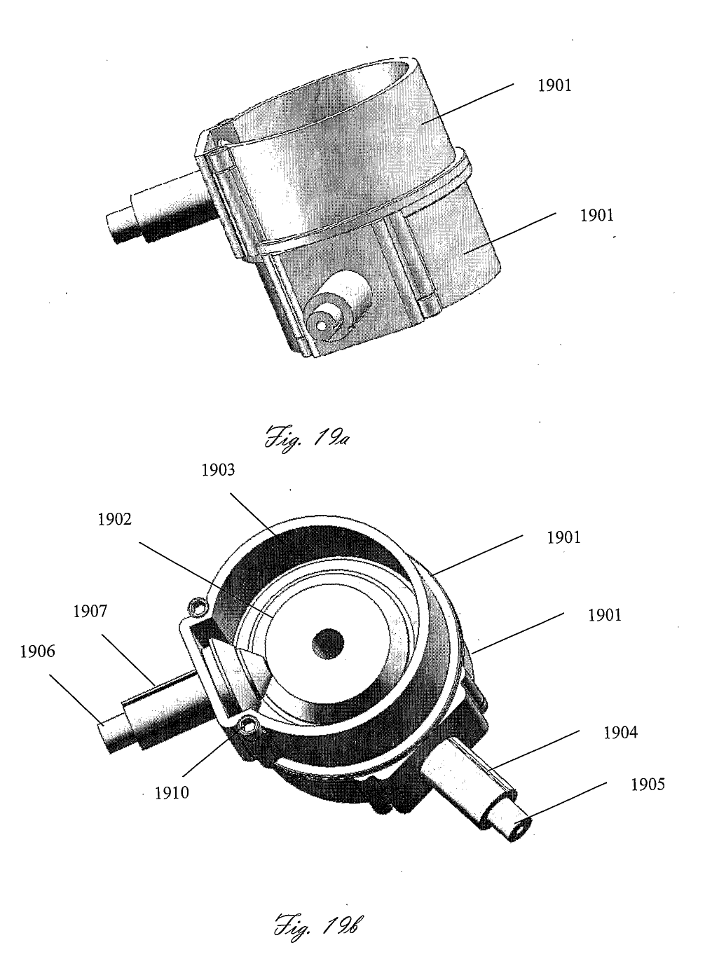

Reference is now made to FIG. 18 illustrating a mechanism that enables 360 degree change in direction. In other words, the output shafts may change direction in 360 degrees and can actually be rotated at will with no restriction since the output shafts are at different heights and do not interfere with one another even at a relative angle of 0°.

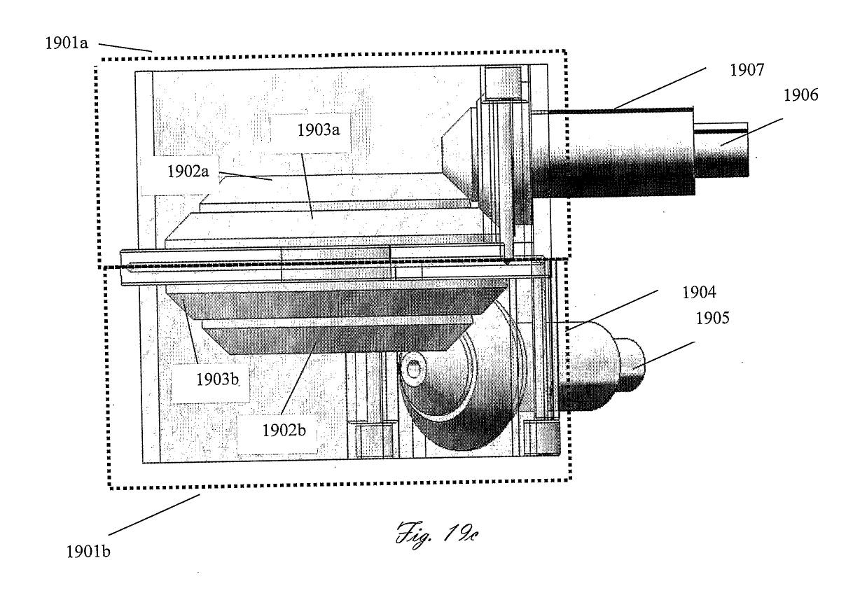

Reference is now made to FIGS. 19a-19c illustrating an embodiment allowing unlimited rotation of the output shaft axis of rotation with respect to the input shaft axis of rotation. In said embodiment, a housing is shown 1901 (see FIG. 19a) for each of the input and the output shafts.

An isometric view is illustrated in FIG. 19b. Also illustrated in FIG. 19b are the intermediate gears (denotes as 1902 and 1903), the input shafts (1904, 1905) and the output shafts (1906, 1907).

A screw 1910 is also illustrated to affix the two housings to lock the relative axis orientations.

By affixing one of the gears to the housing (including either one of the input or output gears), one can rotate the housing to each direction. A better understanding of such affixation can be seen from FIG. 19c.

FIG. 19c illustrates the output shafts (1906 and 1907), the output housing 1901a, the output intermediate gears (1902a, 1903a), the input intermediate gears (1902b, 1903b) and the input shafts (1904, 1905).

By affixing the intermediate gear 1903a to the output housing 1901a, the output housing 1901a itself will be caused to rotate about its center, whilst torque and movement can be transferred through the intermediate gear 1903b and the intermediate gear 1902b.

In the foregoing description, embodiments of the invention, including preferred embodiments, have been presented for the purpose of illustration and description. They are not intended to be exhaustive or to limit the invention to the precise form disclosed. Obvious modifications or variations are possible in light of the above teachings. The embodiments were chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

1. A constant velocity joint comprising:
a. n coaxial input shafts adapted to be rotated around an input axis of rotation by m sources of independent torques, where n and m are positive integers;
b. n coaxial input transmission means, each of which is coupled to one of said n input shafts; said input transmission means defining a first plane; said first plane is positioned at an angle A with respect to said input axis of rotation;
c. n coaxial second transmission means rotatably connected to said n input transmission means; said second transmission means rotating in a second plane; said second plane is positioned at an angle A1 with respect to said first plane;
d. n coaxial output transmission means rotatably connected to said n second transmission means; said output transmission means rotating in a third plane; said third plane being positioned at an angle A2 with respect to said second plane;
e. n coaxial output shafts, each of which is coupled to one of said n output transmission means, said n output shafts being adapted to rotate around an output axis of rotation;
wherein rotation of said input shaft at a constant velocity will provide a constant velocity at the corresponding output shaft; further wherein the angle between said input axis of rotation and said output axis of rotation varies in said second plane in an unlimited angular range of about 0 to about 360 degrees or greater.

2. A constant velocity joint comprising:
a. a plurality of constant velocity joints each comprising:
i. n coaxial input shafts adapted to be rotated around an input axis of rotation by m sources of independent torques, where n and m are positive integers;
ii. n coaxial input transmission means, each of which is coupled to one of said n input shafts; said input transmission means rotating in a first; said first plane is positioned at an angle A with respect to said input axis of rotation;
iii. n coaxial second transmission means rotatably connected to said n input transmission means; said second transmission means rotating in a second plane; said second plane is positioned at an angle A1 with respect to said first plane;
iv. n coaxial output transmission means rotatably connected to said n second transmission means; said output transmission means rotating in a third plane; said third plane being positioned at an angle A2 with respect to said second plane;
v. n coaxial output shafts, each of which is coupled to one of said n output transmission means, said n output shafts are adapted to rotate around an output axis of rotation;
b. coupling means for coupling each of said output shafts of each said constant velocity joint to said input shafts of each subsequent constant velocity joint;
whereby turning a given input shaft at a constant velocity will provide a constant velocity at the corresponding output shaft, and furthermore wherein the angle between said first input axis of rotation and said final output axis of rotation varies in said second planes in an unlimited angular range of about 0 to about 360 degrees or greater.

3. The constant velocity joint according to claim 2, wherein said angles A, A1 and A2 are in the range of more than about 0 degrees and less than about 360 degrees.

4. The constant velocity joint according to claim 2, wherein said input transmission means, second transmission means, and said output transmission means are selected from a group consisting of gearwheels, wheels, crown gears, bevel gears, spur gears, belts, or any combination thereof.

5. The constant velocity joint according to claim 2, additionally comprising
a. an axial support member (601) adapted to provide axial support to said n output shafts in said third plane; and,
b. a circular track (618) centered on the axis of rotation of said second transmission means, said axial support member being adapted to fit into said track and slide within it.

6. The constant velocity joint according to claim 2, additionally comprising a radial support member (604) adapted to provide radial support to said n output shafts, said radial support member being adapted to rotate in said second plane.

7. The constant velocity joint according to claim 2 wherein the gear ratio between said input and output shafts is between about 10 and about 0.1.

8. The constant velocity joint according to claim 2 additionally comprising n coaxial auxiliary shafts in rotating communication with said n second transmission means, said n coaxial auxiliary shafts rotating in said second plane, and said n coaxial auxiliary shafts capable of either being driven by said input shafts or driving said input shafts.

9. The constant velocity joint according to claim 2 additionally comprising locking means adapted for preventing relative movement between one or more of said input axis shafts and said constant velocity joint, wherein said constant velocity joint is caused to rotate as a body with said locked input axis shafts.

10. The constant velocity joint according to claim 2 additionally comprising locking means 1403 for preventing relative movement between one or more of said output axis shafts 1401 and said constant velocity joint, wherein said constant velocity joint is caused to rotate as a body with said locked output axis shafts.

11. The constant velocity joint according to claim 2 additionally comprising one or more coaxial output shafts (1001, 1002) each coupled to said n coaxial second transmission means or to said n coaxial output transmission means.

12. The constant velocity joint according to claim 2, additionally comprising one or more additional output shafts 1302 coupled to said n coaxial second transmission means.

13. A method for transmitting torque to output shafts of variable angle comprising steps of:
a. providing n coaxial input shafts adapted to be rotated around an input axis of rotation by m sources of independent torques, where n and m are positive integers;
b. providing n coaxial input transmission means, said input transmission means defining a first plane; said first plane is positioned at an angle A with respect to said input axis of rotation;
c. coupling each of said input transmission means to one of said n input shafts;
d. providing n coaxial second transmission means rotatably connected to said n input transmission means; said second transmission rotating in a second plane; said second plane is positioned at an angle A1 with respect to said first plane;
e. providing n coaxial output transmission means rotatably connected to said n second transmission means; said output transmission means rotating in a third plane; said third plane being positioned at an angle A2 with respect to said second plane;
f. providing n coaxial output shafts, said n output shafts are adapted to rotate around an output axis of rotation; and
g. coupling each of said output transmission means to one of said n output shafts;
h. rotating one or more of said coaxial input shafts by means of an external source of torque,
thereby transmitting said torque to said coaxial output shafts whilst allowing variation of the angle between said input axis of rotation and said output axis of rotation in said second plane in an unlimited angular range of about 0 to about 360 degrees or greater.

14. A method for transmitting torque to output shafts of variable angle comprising steps of:
a. providing a plurality of constant velocity joints each comprising:
i. n coaxial input shafts adapted to be rotated around an input axis of rotation by m sources of independent torques, n and m are positive integers;
ii. n coaxial input transmission means, each of which is coupled to one of said n input shafts; said input transmission means rotating in a first plane; said first plane is positioned at an angle A with respect to said input axis of rotation;
iii. n coaxial second transmission means rotatably connected to said n input transmission means; said second transmission means rotating in a second plane; said second plane is positioned at an angle A1 with respect to said first plane;
iv. n coaxial output transmission means rotatably connected to said n second transmission means; said output transmission means rotating in a third plane; said third plane being positioned at an angle A2 with respect to said second plane;
v. n coaxial output shafts, each of which is coupled to one of said n output transmission means, said n output shafts are adapted to rotate around an output axis of rotation;
b. coupling said output shaft of each said constant velocity joint to said input shaft of each subsequent constant velocity joint; and.
c. rotating one or more of said coaxial input shafts by means of external sources of torque, thereby transmitting torque to each of said coaxial output shafts whilst allows varying the angle between said input axis of rotation and said output axis of rotation in any plane in an unlimited angular range of about 0 to about 360 degrees or greater.

15. The method according to claim 14, additionally comprising step of selecting said angle A, A1 and A2 from the range of more than about 0 degrees and less than about 360 degrees.

16. The method according to claim 14, additionally comprising step of selecting said input transmission means, second transmission means, said output transmission means from a group consisting of gearwheels, wheels, crown gears, bevel gears, spur gears, belts, or any combination thereof.

17. The method according to claim 14, additionally comprising step of providing each of said constant velocity joints with
a. an axial support member (601) adapted to provide axial support to said n output shafts in said third plane; and,
b. a circular track (618) centered on the axis of rotation of said second transmission means, said axial support member being adapted to fit into said track and slide within it.

18. The method according to claim 14, additionally step of providing each of said constant velocity joints with a radial support member (604) adapted to provide radial support to said n output shafts, said radial support member being adapted to rotate in said second plane.

19. The method according to claim 14, additionally comprising step of providing a gear ratio between said input and output shafts is between about 10 and about 0.1.

20. The method according to claim 14 additionally comprising the step of providing n coaxial auxiliary shafts in rotating communication with said n second transmission means, said n coaxial auxiliary shafts rotating in said second plane, and said n coaxial auxiliary shafts either being driven by said input shafts or driving said input shafts.

21. The method according to claim 14, additionally comprising step of preventing relative movement between one or more of said input axis shafts and said constant velocity joint via locking means, wherein said constant velocity joint is caused to rotate as a body with said locked input axis shafts.

22. The method according to claim 14 additionally comprising step of preventing relative movement between one or more of said output axis shafts and said constant velocity joint via locking means, wherein said constant velocity joint is caused to rotate as a body with said locked output axis shafts.

23. The method according to claim 14 additionally comprising step of providing one or more coaxial output shafts 1001, 1002 each coupled to said n coaxial second transmission means.

24. The method according to claim 14, additionally comprising step of providing one or more additional output shafts 1302 coupled to said n coaxial second transmission means.

25. An article of manufacture comprising the joint as defined in claim 1 or any of its dependent claims, wherein said joint is used to allow variation of the angle between said input axis of rotation and said output axis of rotation in an angular range of about 0 to about 360 degrees.

26. The article of manufacture of claim 25, wherein said article of manufacture is selected from a group comprising: bicycle, two-wheel-drive bicycle, robot, robotic arm, robotic arm with force feedback, remote sensing device, manipulator, and motor vehicle.
